(19) United States
(12) Patent Application Publication
(10) Pub. No.: US 2008/0039985 A1
(43) Pub. Date: Feb. 14, 2008

(54) METHOD AND DEVICE OF ASSISTING IN THE PILOTING OF AN AIRCRAFT IN A SEARCH AND RESCUE MISSION

(75) Inventors: Eric PEYRUCAIN, Saint Genies Bellevue (FR); Arnaud DE SOUQUAL, TOULOUSE (FR)

Correspondence Address: STEVENS DAVIS MILLER & MOSHER, LLP, 1615 L STREET, NW, SUITE 850, WASHINGTON, DC, 20036, US

(73) Assignee: AIRBUS FRANCE, TOULOUSE (FR)

(21) Appl. No.: 11/738,600

(22) Filed: Apr. 23, 2007

(30) Foreign Application Priority Data
Apr. 24, 2006 (FR) 06 03602

(51) Int. Cl. G05D 1/00

(52) U.S. Cl. 701/3

(57) ABSTRACT

A method and device to assist in the piloting of an aircraft in a search and rescue mission.

The device (1) comprises means (7) for recording the actual position of the aircraft on detection of a disengagement of a managed automatic mode, if particular flight conditions are satisfied in a search and rescue mission, and means (8) for inserting this actual position into the flight plan of the aircraft.

The present invention relates to a method and a device to assist in the piloting of an aircraft in a search and rescue mission.

It is known that, when a search and rescue (SAR) mission is planned, for example to search for people and/or an apparatus such as an aircraft, in particular after a crash, the crew of the aircraft that is to carry out the search defines a search path (or a search pattern) to cover a precise search area with this aircraft. Normally, this search area is determined based on the latest available information concerning the objective, such as the circumstances of a crash for example. Furthermore, to perform this search and rescue mission as effectively as possible, and in particular to free the pilot as much as possible from piloting tasks, the aircraft is normally automatically guided along this predefined search path, by means of a standard automatic pilot device that is preferably engaged in managed mode.

If, during a search of this type, the crew of the aircraft receives information from outside, such as the receipt of a radar echo or the sight of a source of smoke in the distance for example, it may have to temporarily leave the search path being followed to fly over an auxiliary area that it did not originally have to fly over, but that it now wants to check. If this check is unsuccessful and the objective (aircraft or people to be saved) has not been found in this auxiliary area, the crew needs to have the option to return to the search path along which it was previously flying, without leaving any gaps in the search area to be covered.

To perform such a check, the only means enabling the pilot to modify the flight plan is to act on a man/machine interface of a flight management system (FMS), to order an interruption of the search mission, in order to enable him to insert into the flight plan a point representing the position where the aircraft left the search path. It is then necessary for the pilot to disengage the managed mode of the automatic piloting device to have the aircraft fly in selected mode or in manual mode towards the auxiliary area to be checked.

This checking procedure presents several drawbacks. Firstly, it increases the workload of the pilot. In practice, the pilot must first select a control to interrupt the search mission SAR to create an interruption point, and he must then disengage the managed mode to leave the search path. In addition, a small position offset appears between the place where the interruption point is created and the place where the aircraft actually leaves the search path. Furthermore, secondly, when the pilot selects the interruption control which is on an item of cockpit equipment, that is head down, he cannot at the same time look outside the cockpit, and is therefore obliged to temporarily stop visual surveillance, which is obviously not satisfactory.

The present invention relates to a method of assisting in the piloting of an aircraft in a search and rescue mission, which makes it possible to overcome the abovementioned drawbacks.

To this end, according to the invention, said method is noteworthy in that, in a search and rescue (SAR) mission:
a) a check is carried out to see if the following flight conditions are simultaneously satisfied:
   a1) the aircraft is flying along a search path in accordance with a flight plan;
   a2) the aircraft is automatically guided by an automatic pilot device in a managed mode; and
   a3) valid information concerning the actual position of the aircraft is available on board;
b) the piloting of the aircraft is monitored so as to be able to detect a disengagement of said managed mode; and
c) if said flight conditions are simultaneously satisfied, when a disengagement of said managed mode is detected, the following operations are carried out automatically:
   c1) the current actual position of the aircraft is determined;
   c2) this actual position is recorded; and
   c3) said actual position is inserted into said flight plan.

Furthermore, in a step c4), said actual position is automatically displayed on at least one display screen of the aircraft.

Thus, with the invention, the pilot no longer needs to use the man/machine interface of the flight management system to create an interruption point. The latter (in this case, said actual position of the aircraft) is determined automatically and is inserted automatically into the flight plan, and this immediately a disengagement of the managed mode is detected. The method according to the invention therefore makes it possible to reduce the workload of the pilot to a single action, namely the most intuitive possible, that is the disengagement of the managed mode, which is implemented in the manner specified below. Thus, the pilot can remain focused on the search (visual observation), when an SAR-type mission is interrupted, for example in order to fly over an area not initially planned.

In a particular embodiment, in the step b), a disengagement of the managed mode is detected on detecting one of the following events:
an action by the pilot on a flight control means of the aircraft;
a disconnection of the automatic pilot device, performed on a flight control unit of the aircraft; and
an actuation by the pilot on a heading control means which is provided on said flight control unit.

Moreover, advantageously, if, following a disengagement of the managed mode, the pilot orders a return to said flight path (for example by pressing a standard “DIRTO”-type button):
a return path of the aircraft is automatically determined, enabling it to return to said recorded actual position; and
the aircraft is automatically guided along this return path.

The present invention also relates to a device for assisting in the piloting of an aircraft in a search and rescue mission of the abovementioned SAR type.

According to the invention, said device is noteworthy in that it comprises:
means for checking whether the following flight conditions are simultaneously satisfied:
   the aircraft is flying along a search path in accordance with a flight plan;
   the aircraft is automatically guided by an automatic pilot device in a managed mode; and
   valid information concerning the actual position of the aircraft is available on board;
a monitoring system able to detect a disengagement of said managed mode;
means for determining the current actual position of the aircraft;
means for recording this actual position on detection of a disengagement of said managed mode, if said flight conditions are simultaneously satisfied;
means for inserting said actual position into said flight plan; and, where appropriate
means for displaying said actual position on at least one display screen of the aircraft.

Furthermore, in a particular embodiment, said monitoring system comprises:
means that are able to detect an action by the pilot on a flight control means (for example a mini-stick or a rudder bar) of the aircraft;
means that are able to detect a disconnection of the automatic pilot device, which is performed on a flight control unit FCU of the aircraft; and
means that are able to detect an actuation by the pilot of a heading control means that is provided on said flight control unit.

Thus, with the device according to the invention, on an interruption to a SAR-type search and rescue mission, for which the search aircraft is automatically guided via a standard automatic pilot device in managed mode, the pilot of this aircraft is not obliged to manually revise the flight plan, using a man/machine interface of the flight management system. This revision is done automatically and the pilot can continue to look outside without interrupting the search.

The figures of the appended drawing will clearly show how the invention can be implemented. In these figures, identical references denote similar elements.

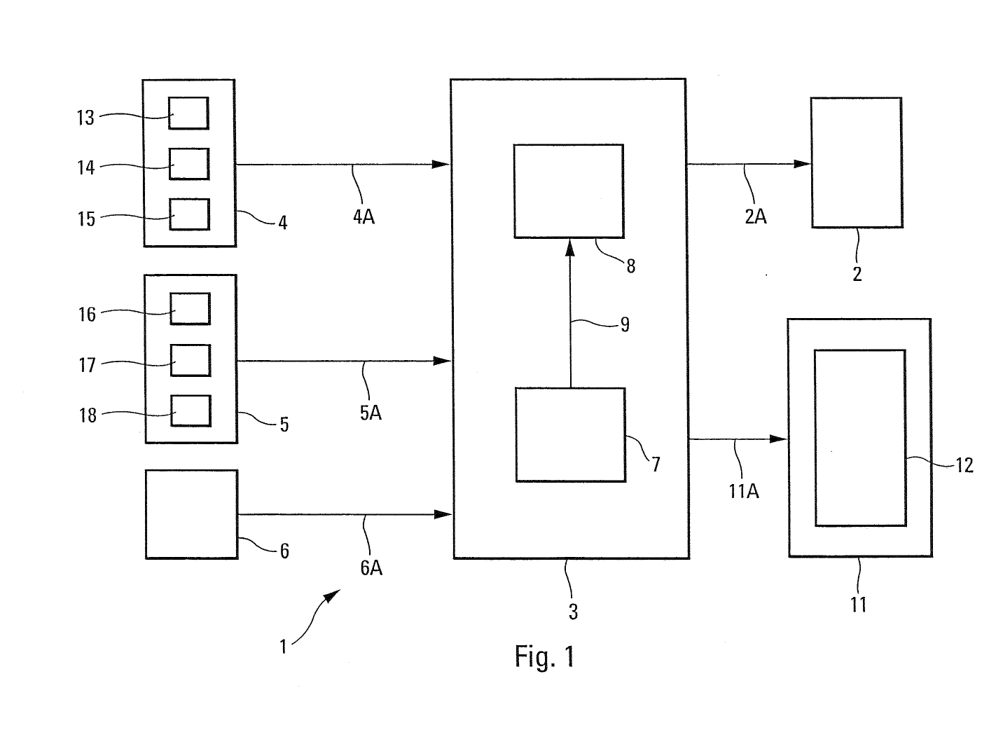

FIG. 1 is the block diagram of a piloting aid device according to the invention.

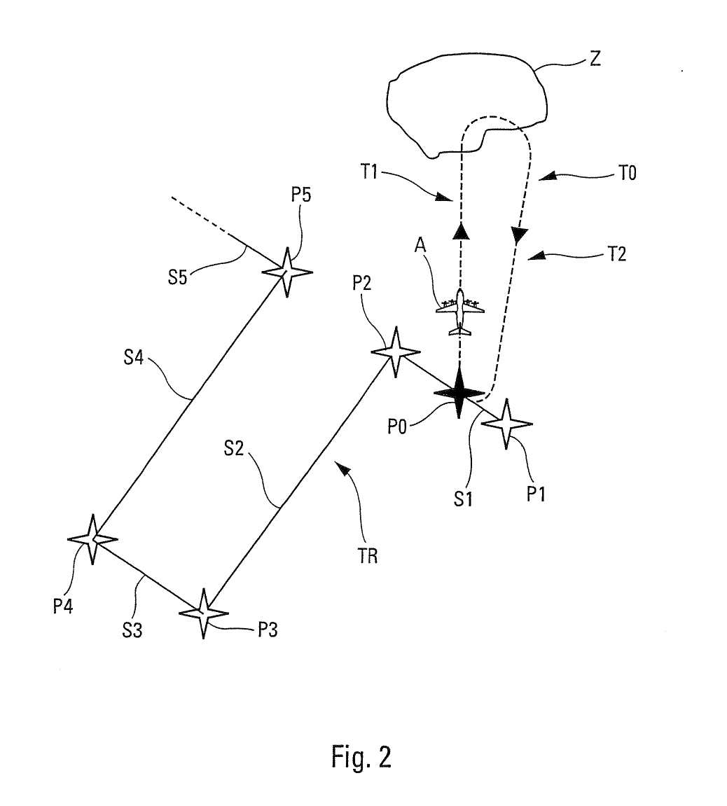

FIG. 2 diagrammatically illustrates a search path followed by an aircraft in a search and rescue mission, with an interruption of the flight along this search path in order to fly over a particular area.

The device 1 according to the invention and diagrammatically represented in FIG. 1 is intended to assist in the piloting of an aircraft, particularly an airplane, in a search and rescue mission, in particular of SAR type.

It is known that, when a search and rescue mission of SAR type is planned, for example to search for people and/or an apparatus such as an aircraft, particularly after a crash, the crew of the aircraft A that is to carry out the search defines a search path TR (or a search pattern) to cover a precise search area with this aircraft A. Normally, this search area is determined based on the latest available information concerning the objective, such as the circumstances of a crash for example. Furthermore, to carry out this search and rescue mission as effectively as possible, the aircraft A is guided automatically along this predefined search path TR, using a standard automatic pilot device 2 which is preferably engaged in managed mode. This automatic pilot device 2 is linked, in the usual way as represented in FIG. 1, via a link 2A to a flight management system (FMS) 3, which provides it in particular with said search path TR.

In one particular embodiment represented in FIG. 2, the search path TR followed by the aircraft A in the search and rescue mission comprises a plurality of flight points P1 to P5 which are interlinked via segments S1 to S5 (which are preferably rectilinear). According to the invention, said device 1 is constructed so as to assist the pilot of the aircraft A when, in an automatic flight along said search path TR, he decides to temporarily leave this search path TR to fly over an area Z that he did not originally have to fly over, but which he now wants to check, for example because he has received a signal from this area. To perform this check, the aircraft A will be guided along a path T0 which comprises a part T1 making it possible to return to said area Z and, where appropriate, a part T2 enabling the aircraft A to return to said search path TR, and more specifically to the point P0 where the aircraft A left said search path TR.

To do this, said device 1 comprises:
a monitoring system 4 which is able to detect a disengagement (detailed below) of a managed mode (which is applied by the automatic pilot device 2 in the SAR mission);
a checking unit 5 to check whether particular flight conditions (specified below) are simultaneously satisfied;
standard means 6 for determining the current actual position of the aircraft A;
means 7 for recording the actual position P0 determined by said means 6, on detection by said monitoring system 4 of a disengagement of said managed mode, in the case where the checking unit 5 has observed that the abovementioned flight conditions are indeed all satisfied; and

means 8 that are linked via a link 9 to said means 7 and that are intended to insert said actual position P0 into the flight plan that was used to determine the search path TR.

In one particular embodiment, said means 7 and 8 are part of the flight management system 3, which is linked via links 4A, 5A and 6A respectively to the monitoring system 4, to the checking unit 5 and to the means 6.

Thus, with the device 1 according to the invention, the pilot no longer needs to use a man/machine interface of a flight management system 3 to create an interruption point. The latter (in the event, said actual position P0 of the aircraft A) is determined automatically and is inserted automatically into the flight plan, and this immediately a disengagement of the managed mode is detected. The device 1 according to the invention therefore makes it possible to reduce the workload of the pilot to a single action, namely the most intuitive possible, that is, the disengagement of the managed mode, which is performed in the manner specified below. Consequently, the pilot can remain focused on the search, when an SAR-type mission is interrupted, for example, to fly over an area Z for which overflight was not initially planned.

Furthermore, said piloting aid device 1 also comprises display means 11 which are, for example, linked via a link 11A to said flight management system 3 (and in particular to said means 7), and which are intended to display said actual position P0 on a standard display screen 12.

In one particular embodiment, said monitoring system 4 comprises:
means 13 that are able to detect an action by the pilot on a flight control means, for example a mini-stick or a rudder bar, of the aircraft;
means 14 that are able to detect a disconnection of the automatic pilot device 2, disconnection that is performed by a manual action by the pilot on a flight control unit FCU, not shown; and
means 15 that are able to detect an actuation by the pilot of a heading control means which is provided on this flight control unit (FCU).

Moreover, in a preferred embodiment, said checking unit 5 comprises:
a means 16 for checking whether the aircraft A is flying along the search path TR in accordance with the flight plan, at the moment when the managed mode is disengaged. This makes it possible to avoid having the device 1 insert a new point into the flight plan each time the pilot takes over the flight controls;
a means 17 for checking whether the aircraft A is automatically guided by the automatic pilot device 2 in a managed mode. In practice, if the pilot follows the search path TR in manual mode or in selected mode, no point is inserted into the flight plan if the aircraft A moves away from the search path TR; and
a means 18 for checking whether the actual position P0 of the aircraft A that is determined by said means 6 is valid, that is, for checking that there is no system failure relating to the measurement of this position.

Moreover, if, following a disengagement of the managed mode as stated above, the pilot orders a return to said flight path TR (for example, by pressing a standard “DIRTO” button):
the device 1 (and in particular the flight management system 3) automatically determines the return path T2 of the aircraft A enabling it to return to said recorded actual position P0; and
the automatic pilot device 2 automatically guides the aircraft A along this return path T2.

Thus, with the device 1 according to the invention, on interrupting a search and rescue SAR-type mission, for which the search aircraft A is automatically guided via the automatic pilot device 2 in managed mode, the pilot of this aircraft A is not obliged to manually revise the flight plan, using a man/machine interface of the flight management system 3. This revision is done automatically, and the pilot can continue to watch outside the aircraft A without interrupting the search.

1. A method of assisting in the piloting of an aircraft (A) in a search and rescue mission,
wherein:
a) a check is carried out to see if the following flight conditions are simultaneously satisfied:
a1) the aircraft (A) is flying along a search path (TR) in accordance with a flight plan;
a2) the aircraft (A) is automatically guided by an automatic pilot device (2) in a managed mode; and
a3) valid information concerning the actual position (P0) of the aircraft (A) is available on board;
b) the piloting of the aircraft (A) is monitored so as to be able to detect a disengagement of said managed mode; and
c) if said flight conditions are simultaneously satisfied, when a disengagement of said managed mode is detected, the following operations are carried out automatically:
c1) the current actual position (P0) of the aircraft (A) is determined;
c2) this actual position (P0) is recorded; and
c3) said actual position (P0) is inserted into said flight plan.

2. The method as claimed in claim 1,
wherein, furthermore, in a step c4), said actual position (P0) is automatically displayed on at least one display screen (12) of the aircraft (A).

3. The method as claimed in claim 1,
wherein, in the step b), a disengagement of the managed mode is detected on detecting one of the following events:
an action by the pilot on a flight control means of the aircraft (A);
a disconnection of the automatic pilot device (2), performed on a flight control unit of the aircraft (A); and
an actuation by the pilot on a heading control means which is provided on said flight control unit.

4. The method as claimed in claim 1,
wherein, if, following a disengagement of the managed mode, the pilot orders a return to said search path (TR):
a return path (T2) of the aircraft (A) is automatically determined, enabling it to return to said recorded actual position (P0); and
the aircraft (A) is automatically guided along this return path (T2).

5. A device for assisting in the piloting of an aircraft in a search and rescue mission,
which comprises:
means (5) for checking whether the following flight conditions are simultaneously satisfied:
the aircraft (A) is flying along a search path in accordance with a flight plan;
the aircraft (A) is automatically guided by an automatic pilot device (2) in a managed mode; and
valid information concerning the actual position (P0) of the aircraft (A) is available on board;
a monitoring system (4) able to detect a disengagement of said managed mode;
means (6) for determining the current actual position (P0) of the aircraft (A);
means (7) for recording this actual position (P0) on detection of a disengagement of said managed mode, if said flight conditions are simultaneously satisfied; and
means (8) for inserting said actual position (P0) into said flight plan.

6. The device as claimed in claim 5,
which comprises, in addition, means (11) for displaying said actual position (P0) on at least one display screen (12).

7. The device as claimed in claim 5,
wherein said monitoring system (5) comprises:
means (13) that are able to detect an action by the pilot on a flight control means of the aircraft (A);
means (14) that are able to detect a disconnection of the automatic pilot device (2), which is performed on a flight control unit of the aircraft (A); and
means (15) that are able to detect an actuation by the pilot of a heading control means that is provided on said flight control unit.

8. An aircraft,
which comprises a device (1) able to implement the method specified under claim 1.

9. An aircraft,
which comprises a device (1) like the one specified under claim 5.
